(19) United States
(12) Patent Application Publication
(10) Pub. No.: US 2024/0314662 A1
(43) Pub. Date: Sep. 19, 2024

(54) TECHNIQUES FOR QUALITY OF EXPERIENCE REPORTING IN HANDOVER

(71) Applicant: QUALCOMM Incorporated, San Diego, CA (US)

(72) Inventors: Shankar KRISHNAN, San Diego, CA (US); Jianhua LIU, Beijing (CN); Xipeng ZHU, San Diego, CA (US); Rajeev KUMAR, San Diego, CA (US)

(21) Appl. No.: 18/260,907

(22) PCT Filed: Mar. 30, 2021
(86) PCT No.: PCT/CN2021/084010

§ 371 Date: Jul. 10, 2023

(51) Int. Cl. H04W 36/30; H04W 36/00

(52) U.S. Cl. CPC H04W 36/304; H04W 36/0058

(57) ABSTRACT

Various aspects of the present disclosure generally relate to wireless communication. In some aspects, a user equipment (UE) may receive, from a first node, a quality of experience (QoE) configuration. The UE may receive, from the first node, a message indicating a handover to a second node that does not support the QoE configuration. The UE may perform, after completion of the handover to the second node. QoE measurements in accordance with the QoE configuration. Numerous other aspects are described.

### FIELD OF THE DISCLOSURE

Aspects of the present disclosure generally relate to wireless communication and to techniques and apparatuses for quality of experience (QoE) reporting in handover.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a base station via the downlink and uplink. “Downlink” (or “forward link”) refers to the communication link from the base station to the UE, and the “uplink” (or “reverse link”) refers to the communication link from the UE to the base station. As will be described in more detail herein, a base station may be referred to as a Node B, a gNB, an access point (AP), a radio head, a transmit receive point (TRP), a New Radio (NR) base station, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a first node, a quality of experience (QoE) configuration: receiving, from the first node, a message indicating a handover to a second node that does not support the QoE configuration; and performing, after completion of the handover to the second node, QoE measurements in accordance with the QoE configuration.

In some aspects, the message includes a different QoE configuration that is supported by the second node.

In some aspects, the method includes transmitting, to the second node, a QoE report in accordance with the different QoE configuration.

In some aspects, the message includes an indication to suspend QoE reporting for the QoE configuration.

In some aspects, the method includes determining to suspend QoE reporting for the QoE configuration based at least in part on one or more of: a determination that a radio bearer for the QoE reporting for the second node is not established; or a determination that the handover is an inter-radio access technology handover.

In some aspects, the method includes receiving, from the second node, another message indicating another handover to a third node that supports the QoE configuration, the other message including an indication to resume QoE reporting for the QoE configuration; and transmitting, to the third node, a QoE report based at least in part on the QoE measurements in accordance with the QoE configuration.

In some aspects, the method includes transmitting a QoE report, based at least in part on the QoE measurements in accordance with the QoE configuration, to the second node for forwarding to the first node.

In some aspects, a method of wireless communication performed by a first node includes transmitting, to a second node, a request message indicating a handover of a UE and a QoE configuration for the UE; receiving, from the second node, a response message indicating that QoE reporting for the QoE configuration is to be suspended, forwarded, or resumed; and transmitting, to the UE, a message indicating the handover to the second node.

In some aspects, the request message further indicates that the QoE reporting for the QoE configuration is to be suspended, and wherein the response message indicates an acknowledgment that the QoE reporting for the QoE configuration is to be suspended.

In some aspects, the response message includes a different QoE configuration that is supported by the second node.

In some aspects, the message includes a different QoE configuration that is supported by the second node.

In some aspects, the message includes an indication to suspend QoE reporting for the QoE configuration.

In some aspects, the request message indicates the QoE configuration based at least in part on at least one of: a determination that a threshold quantity of handovers of the UE is not exceeded; or a determination that the handover to the second node is within a time window.

In some aspects, the request message further indicates that the QoE reporting for the QoE configuration is suspended, and wherein the response message indicates that the QoE reporting for the QoE configuration is to be resumed.

In some aspects, the message includes an indication to resume QoE reporting for the QoE configuration.

In some aspects, the method includes storing the QoE configuration after completion of the handover to the second node.

In some aspects, the method includes receiving, from the second node, a QoE report in accordance with the QoE configuration that was received by the second node from the UE.

In some aspects, a method of wireless communication performed by a first node includes receiving, from a second node, a request message indicating a handover of a UE and a QoE configuration for the UE; and transmitting, to the second node, a response message indicating that QoE reporting for the QoE configuration is to be suspended, forwarded, or resumed.

In some aspects, the response message indicates that the QoE reporting for the QoE configuration is to be suspended based at least in part on a determination that the first node does not support the QoE configuration.

In some aspects, the request message further indicates that the QoE reporting for the QoE configuration is to be suspended, and wherein the response message indicates an acknowledgment that the QoE reporting for the QoE configuration is to be suspended.

In some aspects, the method includes storing the QoE configuration.

In some aspects, the QoE configuration is stored in association with a forwarding indication and an identifier of the second node.

In some aspects, the response message includes a different QoE configuration that is supported by the first node.

In some aspects, the method includes receiving, from the UE, a QoE report in accordance with the different QoE configuration.

In some aspects, the request message further indicates that the QoE reporting for the QoE configuration is suspended, and wherein the response message indicates that the QoE reporting for the QoE configuration is to be resumed.

In some aspects, the response message indicates that the QoE reporting for the QoE configuration is to be resumed based at least in part on a determination that the first node supports the QoE configuration.

In some aspects, the method includes establishing a radio bearer for the QoE reporting.

In some aspects, the method includes receiving, from the UE, a QoE report in accordance with the QoE configuration; and transmitting, to the second node, the QoE report.

In some aspects, a UE for wireless communication includes a memory and one or more processors, coupled to the memory, configured to: receive, from a first node, a QoE configuration: receive, from the first node, a message indicating a handover to a second node that does not support the QoE configuration; and perform, after completion of the handover to the second node, QoE measurements in accordance with the QoE configuration.

In some aspects, the message includes a different QoE configuration that is supported by the second node.

In some aspects, the one or more processors are further configured to: transmit, to the second node, a QoE report in accordance with the different QoE configuration.

In some aspects, the message includes an indication to suspend QoE reporting for the QoE configuration.

In some aspects, the one or more processors are further configured to: determine to suspend QoE reporting for the QoE configuration based at least in part on one or more of: a determination that a radio bearer for the QoE reporting for the second node is not established; or a determination that the handover is an inter-radio access technology handover.

In some aspects, the one or more processors are further configured to: receive, from the second node, another message indicating another handover to a third node that supports the QoE configuration, the other message including an indication to resume QoE reporting for the QoE configuration; and transmit, to the third node, a QoE report based at least in part on the QoE measurements in accordance with the QoE configuration.

In some aspects, the one or more processors are further configured to: transmit a QoE report, based at least in part on the QoE measurements in accordance with the QoE configuration, to the second node for forwarding to the first node.

In some aspects, a first node for wireless communication includes a memory and one or more processors, coupled to the memory, configured to: transmit, to a second node, a request message indicating a handover of a UE and a QoE configuration for the UE; receive, from the second node, a response message indicating that QoE reporting for the QoE configuration is to be suspended, forwarded, or resumed; and transmit, to the UE, a message indicating the handover to the second node.

In some aspects, the request message further indicates that the QoE reporting for the QoE configuration is to be suspended, and wherein the response message indicates an acknowledgment that the QoE reporting for the QoE configuration is to be suspended.

In some aspects, the response message includes a different QoE configuration that is supported by the second node.

In some aspects, the message includes a different QoE configuration that is supported by the second node.

In some aspects, the message includes an indication to suspend QoE reporting for the QoE configuration.

In some aspects, the request message indicates the QoE configuration based at least in part on at least one of: a determination that a threshold quantity of handovers of the UE is not exceeded; or a determination that the handover to the second node is within a time window.

In some aspects, the request message further indicates that the QoE reporting for the QoE configuration is suspended, and wherein the response message indicates that the QoE reporting for the QoE configuration is to be resumed.

In some aspects, the message includes an indication to resume QoE reporting for the QoE configuration.

In some aspects, the one or more processors are further configured to: store the QoE configuration after completion of the handover to the second node.

In some aspects, the one or more processors are further configured to: receive, from the second node, a QoE report in accordance with the QoE configuration that was received by the second node from the UE.

In some aspects, a first node for wireless communication includes a memory and one or more processors, coupled to the memory, configured to: receive, from a second node, a request message indicating a handover of a UE and a QoE configuration for the UE; and transmit, to the second node, a response message indicating that QoE reporting for the QoE configuration is to be suspended, forwarded, or resumed.

In some aspects, the response message indicates that the QoE reporting for the QoE configuration is to be suspended based at least in part on a determination that the first node does not support the QoE configuration.

In some aspects, the request message further indicates that the QoE reporting for the QoE configuration is to be suspended, and wherein the response message indicates an acknowledgment that the QoE reporting for the QoE configuration is to be suspended.

In some aspects, the one or more processors are further configured to: store the QoE configuration.

In some aspects, the QoE configuration is stored in association with a forwarding indication and an identifier of the second node.

In some aspects, the response message includes a different QoE configuration that is supported by the first node.

In some aspects, the one or more processors are further configured to: receive, from the UE, a QoE report in accordance with the different QoE configuration.

In some aspects, the request message further indicates that the QoE reporting for the QoE configuration is suspended, and wherein the response message indicates that the QoE reporting for the QoE configuration is to be resumed.

In some aspects, the response message indicates that the QoE reporting for the QoE configuration is to be resumed based at least in part on a determination that the first node supports the QoE configuration.

In some aspects, the one or more processors are further configured to: establish a radio bearer for the QoE reporting.

In some aspects, the one or more processors are further configured to: receive, from the UE, a QoE report in accordance with the QoE configuration; and transmit, to the second node, the QoE report.

In some aspects, a non-transitory computer-readable medium storing a set of instructions for wireless communication includes one or more instructions that, when executed by one or more processors of a UE, cause the UE to: receive, from a first node, a QoE configuration: receive, from the first node, a message indicating a handover to a second node that does not support the QoE configuration; and perform, after completion of the handover to the second node, QoE measurements in accordance with the QoE configuration.

In some aspects, the message includes a different QoE configuration that is supported by the second node.

In some aspects, the one or more instructions further cause the UE to: transmit, to the second node, a QoE report in accordance with the different QoE configuration.

In some aspects, the message includes an indication to suspend QoE reporting for the QoE configuration.

In some aspects, the one or more instructions further cause the UE to: determine to suspend QoE reporting for the QoE configuration based at least in part on one or more of: a determination that a radio bearer for the QoE reporting for the second node is not established; or a determination that the handover is an inter-radio access technology handover.

In some aspects, the one or more instructions further cause the UE to: receive, from the second node, another message indicating another handover to a third node that supports the QoE configuration, the other message including an indication to resume QoE reporting for the QoE configuration; and transmit, to the third node, a QoE report based at least in part on the QoE measurements in accordance with the QoE configuration.

In some aspects, the one or more instructions further cause the UE to: transmit a QoE report, based at least in part on the QoE measurements in accordance with the QoE configuration, to the second node for forwarding to the first node.

In some aspects, a non-transitory computer-readable medium storing a set of instructions for wireless communication includes one or more instructions that, when executed by one or more processors of a first node, cause the first node to: transmit, to a second node, a request message indicating a handover of a UE and a QoE configuration for the UE; receive, from the second node, a response message indicating that QoE reporting for the QoE configuration is to be suspended, forwarded, or resumed; and transmit, to the UE, a message indicating the handover to the second node.

In some aspects, the request message further indicates that the QoE reporting for the QoE configuration is to be suspended, and wherein the response message indicates an acknowledgment that the QoE reporting for the QoE configuration is to be suspended.

In some aspects, the response message includes a different QoE configuration that is supported by the second node.

In some aspects, the message includes a different QoE configuration that is supported by the second node.

In some aspects, the message includes an indication to suspend QoE reporting for the QoE configuration.

In some aspects, the request message indicates the QoE configuration based at least in part on at least one of: a determination that a threshold quantity of handovers of the UE is not exceeded; or a determination that the handover to the second node is within a time window.

In some aspects, the request message further indicates that the QoE reporting for the QoE configuration is suspended, and wherein the response message indicates that the QoE reporting for the QoE configuration is to be resumed.

In some aspects, the message includes an indication to resume QoE reporting for the QoE configuration.

In some aspects, the one or more instructions further cause the first node to: store the QoE configuration after completion of the handover to the second node.

In some aspects, the one or more instructions further cause the first node to: receive, from the second node, a QoE report in accordance with the QoE configuration that was received by the second node from the UE.

In some aspects, a non-transitory computer-readable medium storing a set of instructions for wireless communication includes one or more instructions that, when executed by one or more processors of a first node, cause the first node to: receive, from a second node, a request message indicating a handover of a UE and a QoE configuration for the UE; and transmit, to the second node, a response message indicating that QoE reporting for the QoE configuration is to be suspended, forwarded, or resumed.

In some aspects, the response message indicates that the QoE reporting for the QoE configuration is to be suspended based at least in part on a determination that the first node does not support the QoE configuration.

In some aspects, the request message further indicates that the QoE reporting for the QoE configuration is to be suspended, and wherein the response message indicates an acknowledgment that the QoE reporting for the QoE configuration is to be suspended.

In some aspects, the one or more instructions further cause the first node to: store the QoE configuration.

In some aspects, the QoE configuration is stored in association with a forwarding indication and an identifier of the second node.

In some aspects, the response message includes a different QoE configuration that is supported by the first node.

In some aspects, the one or more instructions further cause the first node to: receive, from the UE, a QoE report in accordance with the different QoE configuration.

In some aspects, the request message further indicates that the QoE reporting for the QoE configuration is suspended, and wherein the response message indicates that the QoE reporting for the QoE configuration is to be resumed.

In some aspects, the response message indicates that the QoE reporting for the QoE configuration is to be resumed based at least in part on a determination that the first node supports the QoE configuration.

In some aspects, the one or more instructions further cause the first node to: establish a radio bearer for the QoE reporting.

In some aspects, the one or more instructions further cause the first node to: receive, from the UE, a QoE report in accordance with the QoE configuration; and transmit, to the second node, the QoE report.

In some aspects, an apparatus for wireless communication includes means for receiving, from a first node, a QoE configuration; means for receiving, from the first node, a message indicating a handover to a second node that does not support the QoE configuration; and means for performing, after completion of the handover to the second node, QoE measurements in accordance with the QoE configuration.

In some aspects, the message includes a different QoE configuration that is supported by the second node.

In some aspects, the apparatus includes means for transmitting, to the second node, a QoE report in accordance with the different QoE configuration.

In some aspects, the message includes an indication to suspend QoE reporting for the QoE configuration.

In some aspects, the apparatus includes means for determining to suspend QoE reporting for the QoE configuration based at least in part on one or more of: a determination that a radio bearer for the QoE reporting for the second node is not established; or a determination that the handover is an inter-radio access technology handover.

In some aspects, the apparatus includes means for receiving, from the second node, another message indicating another handover to a third node that supports the QoE configuration, the other message including an indication to resume QoE reporting for the QoE configuration; and means for transmitting, to the third node, a QoE report based at least in part on the QoE measurements in accordance with the QoE configuration.

In some aspects, the apparatus includes means for transmitting a QoE report, based at least in part on the QoE measurements in accordance with the QoE configuration, to the second node for forwarding to the first node.

In some aspects, an apparatus for wireless communication includes means for transmitting, to a node, a request message indicating a handover of a UE and a QoE configuration for the UE; means for receiving, from the node, a response message indicating that QoE reporting for the QoE configuration is to be suspended, forwarded, or resumed; and means for transmitting, to the UE, a message indicating the handover to the second node.

In some aspects, the request message further indicates that the QoE reporting for the QoE configuration is to be suspended, and wherein the response message indicates an acknowledgment that the QoE reporting for the QoE configuration is to be suspended.

In some aspects, the response message includes a different QoE configuration that is supported by the node.

In some aspects, the message includes a different QoE configuration that is supported by the node.

In some aspects, the message includes an indication to suspend QoE reporting for the QoE configuration.

In some aspects, the request message indicates the QoE configuration based at least in part on at least one of: a determination that a threshold quantity of handovers of the UE is not exceeded; or a determination that the handover to the node is within a time window.

In some aspects, the request message further indicates that the QoE reporting for the QoE configuration is suspended, and wherein the response message indicates that the QoE reporting for the QoE configuration is to be resumed.

In some aspects, the message includes an indication to resume QoE reporting for the QoE configuration.

In some aspects, the apparatus includes means for storing the QoE configuration after completion of the handover to the node.

In some aspects, the apparatus includes means for receiving, from the node, a QoE report in accordance with the QoE configuration that was received by the node from the UE.

In some aspects, an apparatus for wireless communication includes means for receiving, from a node, a request message indicating a handover of a UE and a QoE configuration for the UE; and means for transmitting, to the node, a response message indicating that QoE reporting for the QoE configuration is to be suspended, forwarded, or resumed.

In some aspects, the response message indicates that the QoE reporting for the QoE configuration is to be suspended based at least in part on a determination that the apparatus does not support the QoE configuration.

In some aspects, the request message further indicates that the QoE reporting for the QoE configuration is to be suspended, and wherein the response message indicates an acknowledgment that the QoE reporting for the QoE configuration is to be suspended.

In some aspects, the apparatus includes means for storing the QoE configuration.

In some aspects, the QoE configuration is stored in association with a forwarding indication and an identifier of the node.

In some aspects, the response message includes a different QoE configuration that is supported by the apparatus.

In some aspects, the apparatus includes means for receiving, from the UE, a QoE report in accordance with the different QoE configuration.

In some aspects, the request message further indicates that the QoE reporting for the QoE configuration is suspended, and wherein the response message indicates that the QoE reporting for the QoE configuration is to be resumed.

In some aspects, the response message indicates that the QoE reporting for the QoE configuration is to be resumed based at least in part on a determination that the apparatus supports the QoE configuration.

In some aspects, the apparatus includes means for establishing a radio bearer for the QoE reporting.

In some aspects, the apparatus includes means for receiving, from the UE, a QoE report in accordance with the QoE configuration; and means for transmitting, to the node, the QoE report.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of quality of experience (QoE) measurement configuration and QoE reporting, in accordance with the present disclosure.

FIGS. 4A-4D are diagram illustrating examples associated with QoE reporting in handover, in accordance with the present disclosure.

FIG. 5 is a diagram illustrating an example associated with QoE reporting in handover, in accordance with the present disclosure.

FIG. 6 is a diagram illustrating an example associated with QoE reporting in handover, in accordance with the present disclosure.

FIGS. 7-9 are diagrams illustrating example processes associated with QoE reporting in handover, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

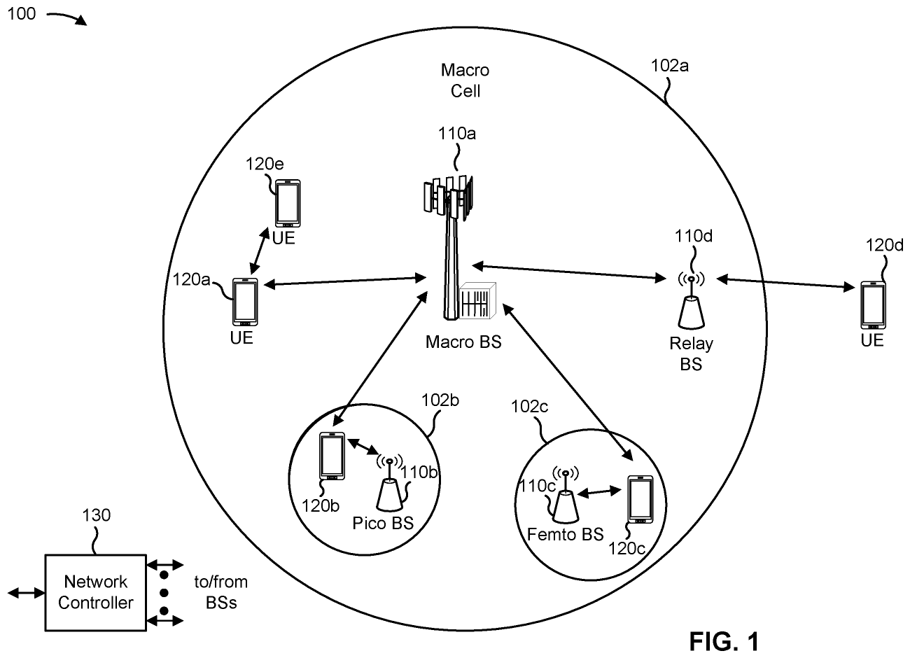

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR base station, a Node B, a gNB, a 5G node B (NB), an access point, a transmit receive point (TRP), or the like. Each base station may provide communication coverage for a particular geographic area. In 3GPP, the term “cell” can refer to a coverage area of a base station and/or a base station subsystem serving this coverage area, depending on the context in which the term is used.

A base station may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A base station for a macro cell may be referred to as a macro base station. A base station for a pico cell may be referred to as a pico base station. A base station for a femto cell may be referred to as a femto base station or a home base station. In the example shown in FIG. 1, a base station 110a may be a macro base station for a macro cell 102a, a base station 110b may be a pico base station for a pico cell 102b, and a base station 110c may be a femto base station for a femto cell 102c. A base station may support one or multiple (e.g., three) cells. The terms “eNB”, “base station”, “NR base station”, “gNB”, “TRP”, “AP”, “node B”, “5G NB”, and “cell” may be used interchangeably herein.

In some aspects, a cell may not necessarily be stationary, and the geographic area of the cell may move according to the location of a mobile base station. In some aspects, the base stations may be interconnected to one another and/or to one or more other base stations or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a base station or a UE) and send a transmission of the data to a downstream station (e.g., a UE or a base station). A relay station may also be a UE that can relay transmissions for other UEs. In the example shown in FIG. 1, a relay base station 110d may communicate with macro base station 110a and a UE 120d in order to facilitate communication between base station 110a and UE 120d. A relay base station may also be referred to as a relay station, a relay base station, a relay, or the like.

Wireless network 100 may be a heterogeneous network that includes base stations of different types, such as macro base stations, pico base stations, femto base stations, relay base stations, or the like. These different types of base stations may have different transmit power levels, different coverage areas, and different impacts on interference in wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to a set of base stations and may provide coordination and control for these base stations. Network controller 130 may communicate with the base stations via a backhaul. The base stations may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrow band internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHZ, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHZ). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

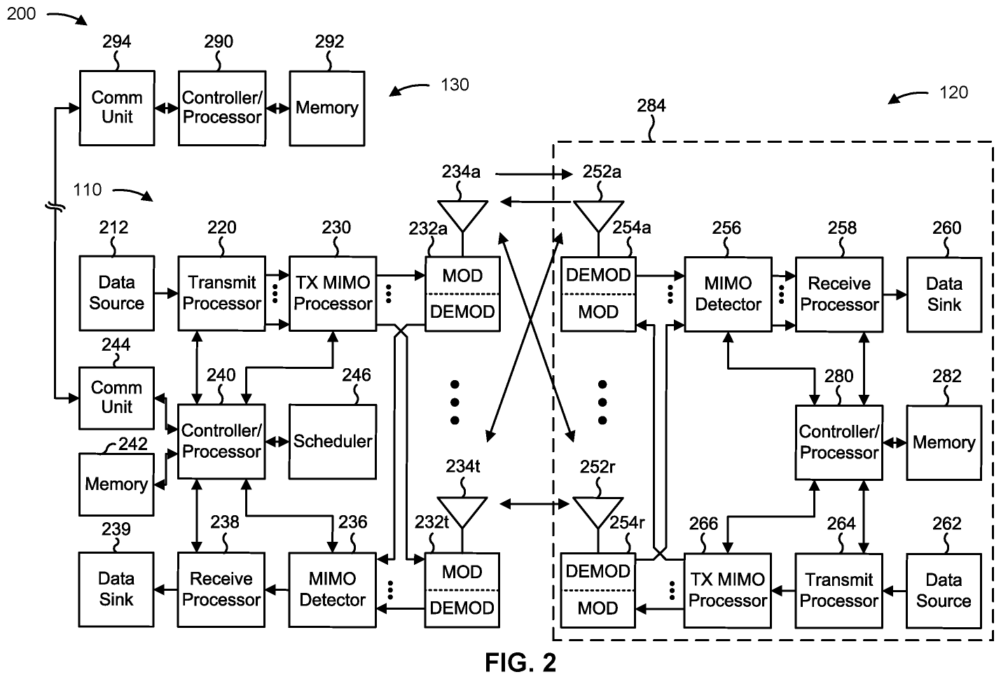

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, an/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

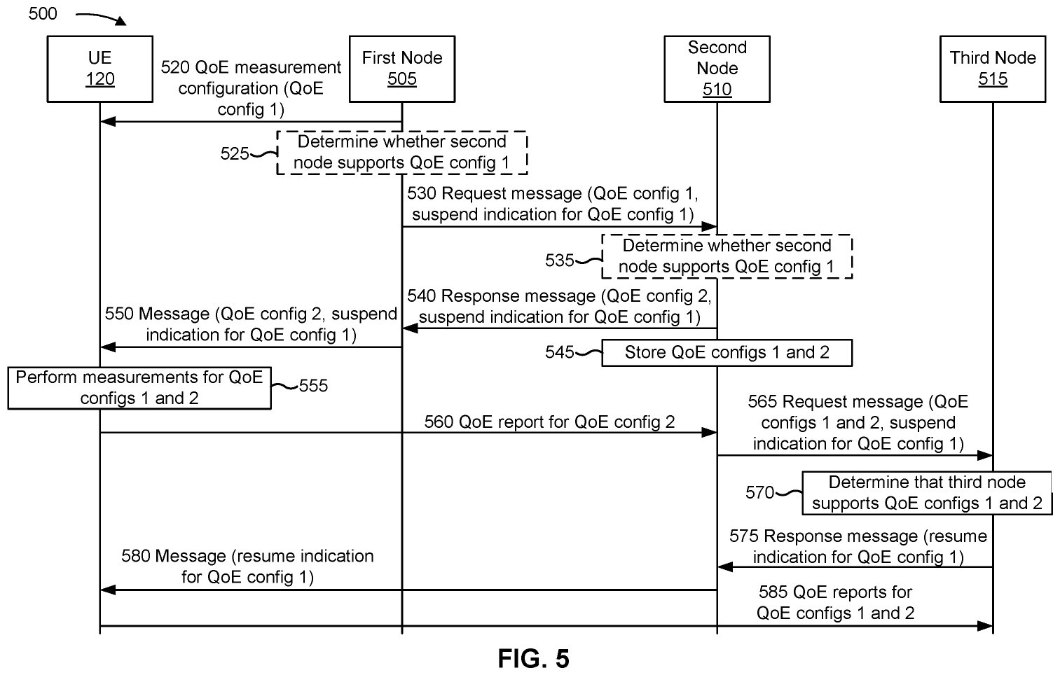

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM) and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 5-9).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 5-9).

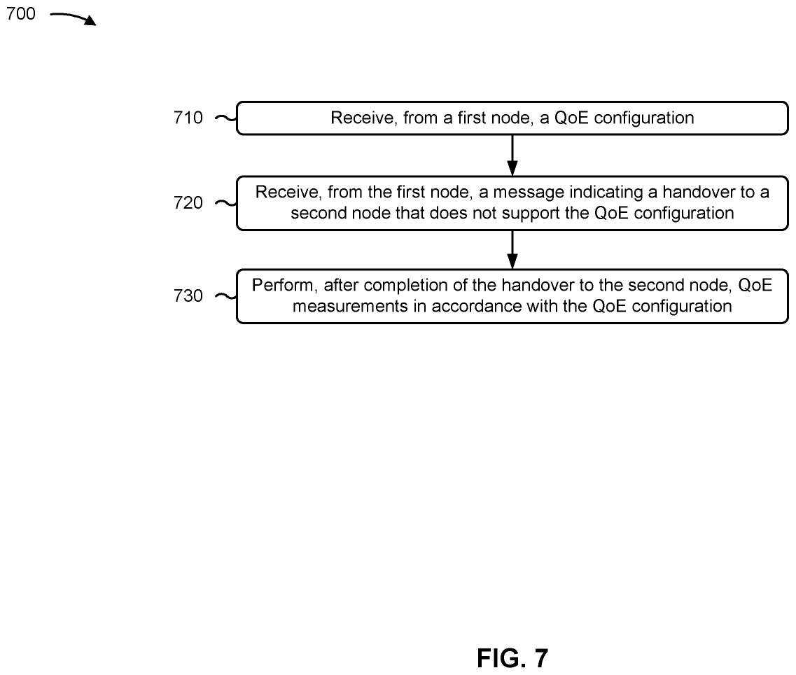

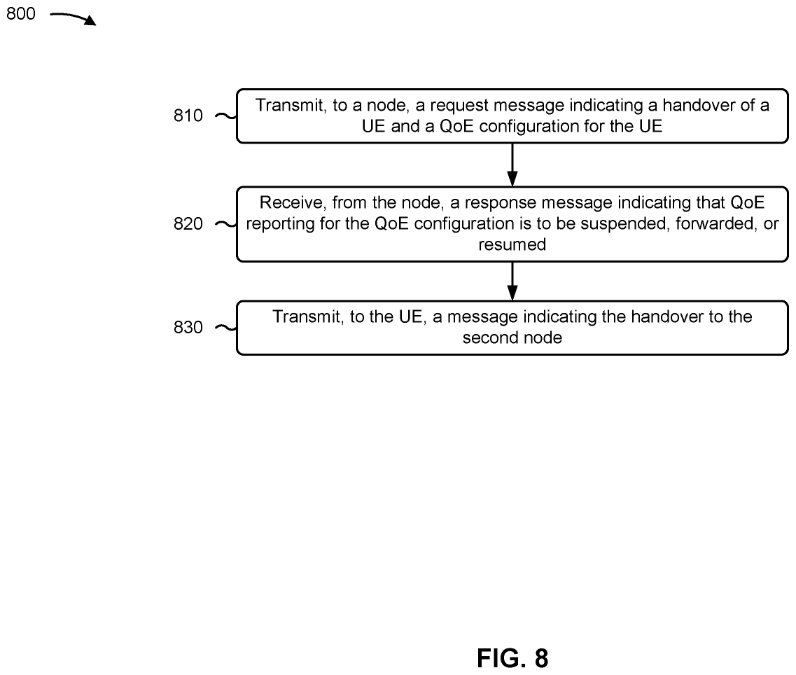

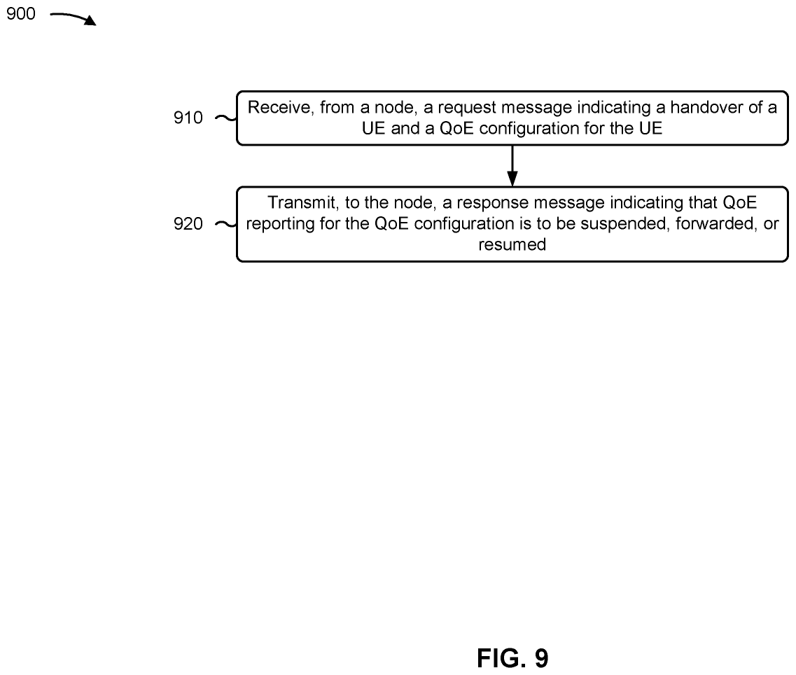

In some aspects, a node described herein is the base station 110, is included in the base station 110, or includes one or more components of the base station 110 shown in FIG. 2. Controller/processor 240 of base station 110, controller/processor 280 of UE 120, and/or any other component(s) of FIG. 2 may perform one or more techniques associated with quality of experience (QoE) reporting in handover, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, and/or other processes as described herein. In some aspects, executing instructions may include running the instructions, converting the instructions, compiling the instructions, and/or interpreting the instructions.

In some aspects, the UE includes means for receiving, from a first node, a QoE configuration; means for receiving, from the first node, a message indicating a handover to a second node that does not support the QoE configuration; and/or means for performing, after completion of the handover to the second node, QoE measurements in accordance with the QoE configuration. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the node includes means for transmitting, to another node, a request message indicating a handover of a UE and a QoE configuration for the UE; means for receiving, from the other node, a response message indicating that QoE reporting for the QoE configuration is to be suspended, forwarded, or resumed; and/or means for transmitting, to the UE, a message indicating the handover to the second node. In some aspects, the node includes means for receiving, from another node, a request message indicating a handover of a UE and a QoE configuration for the UE; and/or means for transmitting, to the other node, a response message indicating that QoE reporting for the QoE configuration is to be suspended, forwarded, or resumed. In some aspects, the means for the node to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

As indicated above, FIG. 2 is provided as an example. Other examples may differ from what is described with regard to FIG. 2.

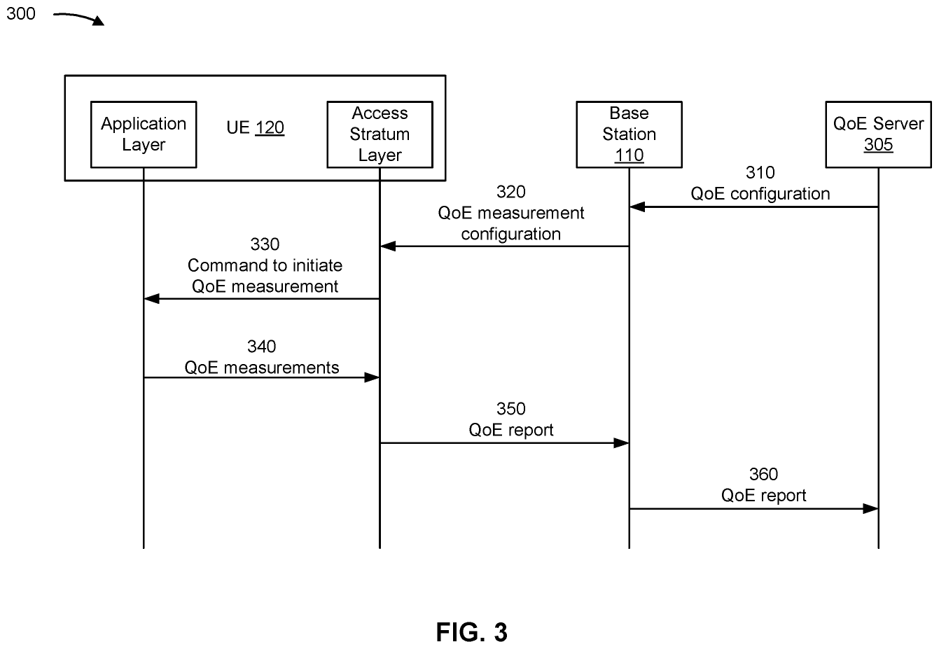

FIG. 3 is a diagram illustrating an example 300 of QoE measurement configuration and QoE reporting, in accordance with the present disclosure. QoE may refer to a level of satisfaction of a user with a service from the user's perspective. Example 300 may include communication between a QoE server 305, a base station 110, and a UE 120. The QoE server 305 may be associated with a network operator that uses the base station 110 (e.g., the QoE server 305 may be associated with an operations, administration, and maintenance (OAM) system). The QoE server 305 may perform operations associated with QoE measurements, such as processing of the QoE information, analysis of the QoE information, determination of key performance indicators (KPIs) based on the QoE information, or the like. The UE 120 may be operating in a radio resource control (RRC) connected (e.g., RRC_CONNECTED) state. In addition, the UE 120 may be configured with a signal radio bearer (SRB) for QoE reporting (e.g., SRB4) for the base station 110.

As shown by reference number 310, the base station 110 may receive, from the QoE server 305, information that identifies a QoE configuration that is to be used by the base station 110 (e.g., for configuring UEs for QoE reporting). As shown by reference number 320, the base station 110 may transmit, and the UE 120 may receive (e.g., at an access stratum layer of the UE), a QoE measurement configuration (e.g., a QoE measurement configuration based at least in part on the QoE configuration received by the base station 110). For example, the base station 110 may transmit an RRC reconfiguration (e.g., RRCReconfiguration) message that indicates the QoE measurement configuration in a measConfigAppLayer information element.

The QoE measurement configuration may identify one or more QoE measurements (e.g., relating to a quality of streaming services used in the UE 120) that are to be collected by the UE 120. A QoE measurement may refer to a measurement (e.g., relating to bit rate, drop rate, connection failure, jitter, playback time, or the like) that is for use in determining a QoE, a QoE metric, a QoE KPI, or the like. The QoE measurement configuration also may identify one or more service types (e.g., a multimedia telephony service for internet protocol multimedia subsystem (MTSI), a streaming service, and/or a multimedia broadcast multicast service (MBMS), among other examples) for which the UE 120 is to perform QoE measurements.

As shown by reference number 330, the UE 120, via the access stratum layer, may provide a command to initiate QoE measurement to an application layer of the UE 120. That is, the command may be a command to initiate QoE measurement collection (QMC). The command may be a mobile station modem (MSM) interface/attention (AT) command. As shown by reference number 340, the UE 120, via the application layer, may provide QoE measurements to the access stratum layer. The QoE measurements may be per service type indicated by the QoE measurement configuration.

As shown by reference number 350, the UE 120 may transmit (e.g., using the access stratum layer), and the base station 110 may receive, a QoE report. For example, the UE 120 may transmit a meas ReportAppLayer message that indicates the QoE report. The QoE report may be based at least in part on the QoE measurements collected by the UE 120. For example, the QoE report may identify the QoE measurements collected by the UE 120 (e.g., per service type). As shown by reference number 360, the base station 110 may transmit the QoE report, or information associated with the QoE report, to the QoE server 305.

As indicated above, FIG. 3 is provided as an example. Other examples may differ from what is described with respect to FIG. 3.

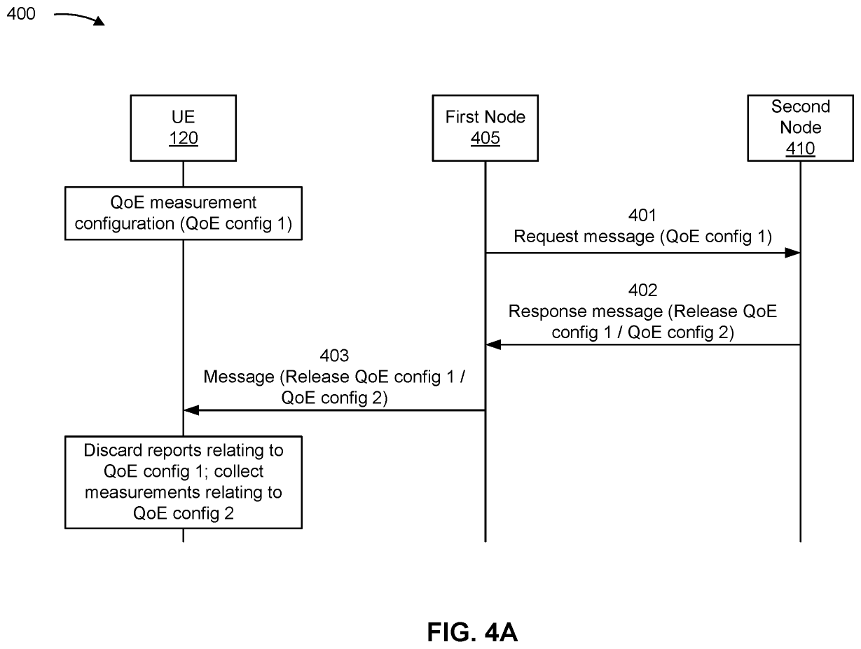

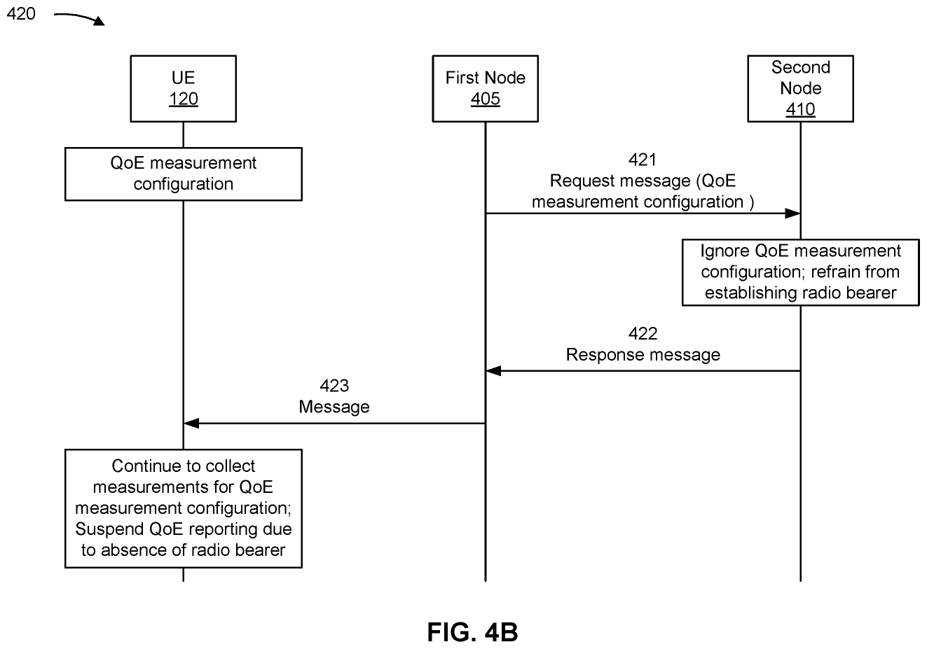

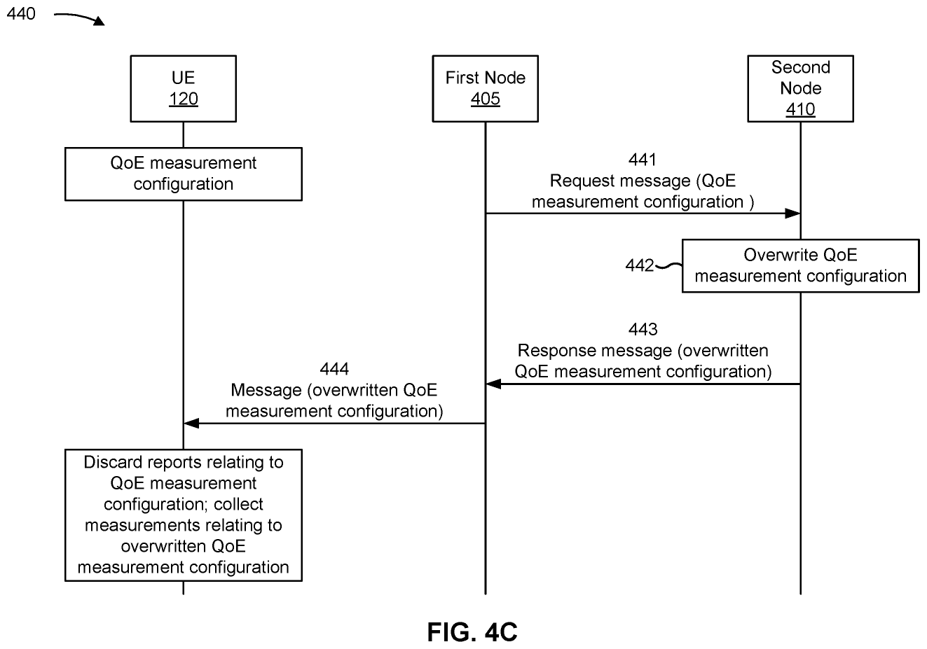

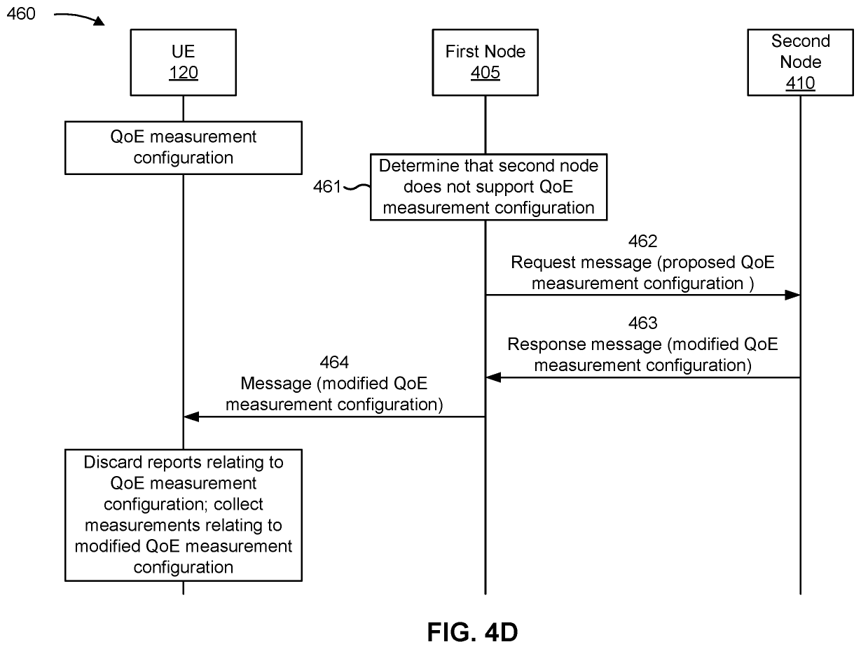

FIGS. 4A-4D are diagrams illustrating examples 400, 420, 440, and 460 of QoE reporting in handover, in accordance with the present disclosure. As shown in FIGS. 4A-4D, examples 400, 420, 440, and 460 include communication between a UE 120, a first node 405 (e.g., a wireless node), and a second node 410 (e.g., a wireless node). The first node 405 and the second node 410 may be base stations 110, or other nodes that perform one or more functions of a base station 110. The first node 405 may be a source node in a handover of the UE 120, and the second node 410 may be a target node in the handover of the UE 120. The first node 405 and the second node 410 may use different RATs. For example, the first node 405 may be associated with a next generation radio access network (NG-RAN) (e.g., the first node 405 may use a 5G RAT), and the second node 410 may be associated with an evolved universal mobile telecommunications system (UMTS) terrestrial radio access network (E-UTRAN) (e.g., the second node 410 may use an LTE RAT).

The UE 120 may be configured (e.g., by the first node 405) with a QoE configuration (“QoE config 1”), such as a QoE measurement configuration, a QoE reporting configuration, or the like. The first node 405 may support the QoE configuration. The second node 410 may not support the QoE configuration. A node supports a QoE configuration if the node supports QoE measurement reporting in accordance with the QoE configuration (e.g., the node is capable of recognizing and/or processing a QoE report in accordance with the QoE configuration). As used herein, a node supports a QoE configuration if the node fully supports the QoE configuration (e.g., the node is capable of recognizing and/or processing all of a QoE report in accordance with the QoE configuration). As used herein, a node does not support a QoE configuration if the node does not fully support the QoE configuration (e.g., the node does not support any QoE reporting in accordance with the QoE configuration or the node only partially supports QoE reporting in accordance with the QoE configuration).

As shown in FIG. 4A, and by reference number 401, the first node 405 may transmit, to the second node 410, a request message (e.g., a handover request) indicating handover of the UE 120. The request message may include the QoE configuration (QoE config 1). As shown by reference number 402, the second node 410 may transmit, to the first node 405, a response message (e.g., a handover response) acknowledging (e.g., accepting) the handover of the UE 120. The response message may include an indication to release the QoE configuration (QoE config 1). In some examples, the response message may include a different QoE configuration (“QoE config 2”) that is supported by the second node 410.

As shown by reference number 403, the first node 405 may transmit a message (e.g., an RRC reconfiguration message) to the UE 120 indicating the handover to the second node 410 (e.g., a handover command). The message may indicate that the UE 120 is to release the QoE configuration (QoE config 1). In some examples, the message may indicate that the UE 120 is to use the different QoE configuration (QoE config 2). Accordingly, the UE 120 may discard any stored QoE measurements/QoE reports relating to the QoE configuration (QoE config 1), and the UE 120 may initiate collection of measurements in accordance with the different QoE configuration (QoE config 2).

As shown in FIG. 4B, and by reference number 421, the first node 405 may transmit, to the second node 410, a request message (e.g., a handover request) indicating handover of the UE 120. The request message may include the QoE configuration. The second node 410, which does not support (e.g., understand) QoE reporting, may ignore the QoE configuration and may refrain from establishing a radio bearer (e.g., SRB4) for QoE reporting for the QoE configuration (e.g., and thus, the second node 410 does not expect to receive QoE measurements from the UE 120). As shown by reference number 422, the second node 410 may transmit, to the first node 405, a response message (e.g., a handover response) acknowledging (e.g., accepting) the handover of the UE 120. As shown by reference number 423, the first node 405 may transmit a message (e.g., an RRC reconfiguration message) to the UE 120 indicating the handover to the second node 410 (e.g., a handover command).

The UE 120 may continue to collect QoE measurements in accordance with the QoE configuration (e.g., because the message received from the first node 405 did not indicate release of the QoE configuration). However, the UE 120 may suspend QoE reporting for the QoE configuration due to the absence of the radio bearer for QoE reporting. Thus, the absence of the radio bearer for the QoE reporting indicates (implicitly) to the UE 120 to suspend the QoE reporting.

As shown in FIG. 4C, and by reference number 441, the first node 405 may transmit, to the second node 410, a request message (e.g., a handover request) indicating handover of the UE 120. The request message may include (e.g., forward) the QoE configuration. As shown by reference number 442, the second node 410, which does not support the QoE configuration, may overwrite the QoE configuration in accordance with QoE features supported by the second node 410 (e.g., the second node 410 may perform autonomous overwriting of the QoE configuration). As shown by reference number 443, the second node 410 may transmit, to the first node 405, a response message (e.g., a handover response) acknowledging (e.g., accepting) the handover of the UE 120. The response message may include the overwritten QoE configuration that is supported by the second node 410.

As shown by reference number 444, the first node 405 may transmit a message (e.g., an RRC reconfiguration message) to the UE 120 indicating the handover to the second node 410 (e.g., a handover command). The message may indicate that the UE 120 is to use the overwritten QoE configuration (e.g., the message may include the full overwritten QoE configuration). Accordingly, the UE 120 may discard any stored QoE measurements/QoE reports relating to the QoE configuration, and the UE 120 may initiate collection of measurements in accordance with the overwritten QoE configuration.

As shown in FIG. 4D, and by reference number 461, the first node 405 may determine that the second node 410 does not support the QoE configuration (e.g., based at least in part on information that identifies the QoE capabilities of the second node 410). As shown by reference number 462, the first node 405 may transmit, to the second node 410, a request message (e.g., a handover request) indicating handover of the UE 120. The request message may include a proposed QoE configuration (e.g., based at least in part on the QoE capabilities of the second node 410). The second node 410 may determine a modified QoE configuration based at least in part on the proposed QoE configuration (e.g., the second node 410 may perform assisted overwriting of the QoE configuration). As shown by reference number 463, the second node 410 may transmit, to the first node 405, a response message (e.g., a handover response) acknowledging (e.g., accepting) the handover of the UE 120. The response message may include the modified QoE configuration (e.g., based at least in part on the proposed QoE configuration) that is supported by the second node 410.

As shown by reference number 464, the first node 405 may transmit a message (e.g., an RRC reconfiguration message) to the UE 120 indicating the handover to the second node 410 (e.g., a handover command). The message may indicate that the UE 120 is to use the modified QoE configuration (e.g., the message may include the modified QoE configuration). Accordingly, the UE 120 may discard any stored QoE measurements/QoE reports relating to the QoE configuration, and the UE 120 may initiate collection of measurements in accordance with the modified QoE configuration.

As indicated above, FIGS. 4A-4D are provided as examples. Other examples may differ from what is described with respect to FIGS. 4A-4D.

In some examples, a UE (e.g., an application client of the UE) may reference a QoE configuration only at the start of a session (e.g., according to a rule implemented by the UE). Thus, QoE logging and reporting criteria for an ongoing session may be unaffected by QoE configuration changes received by the UE during the session. As a result, the UE may continue QoE measurements for the session even if the UE moves out of a configured area (e.g., in which QoE measurements are to be collected) or is handed over to a new cell. For example, the UE may reference the QoE configuration only at the start of the session even if the UE undergoes an inter-RAT handover (e.g., from a 5G RAT to an LTE RAT, or from an LTE RAT to a 5G RAT).

However, in some examples, a target node for handover of the UE may not support (e.g., entirely or partially) a QoE configuration configured by a source node. For example, the target node may not support the QoE configuration in a scenario involving inter-RAT mobility (e.g., between NG-RAN source node and an E-UTRAN target node) and/or intra-RAT mobility (e.g., between a source node that supports the QoE configuration and a target node that does not support the QoE configuration). However, the UE may continue to perform QoE measurements in accordance with the QoE configuration, as described above. As a result, processing resources of the UE are consumed by performing QoE measurements, even though the measurements are to be discarded and not reported by the UE.

Described herein are techniques and apparatuses for QoE reporting in handover. For example, some techniques and apparatuses described herein enable continuity of QoE configuration, measurement, and reporting in handover of the UE from a source node, that supports a QoE configuration, to a target node that does not support the QoE configuration.

In some aspects, the UE 120 may receive an indication to suspend QoE reporting for a QoE configuration during handover to a cell that does not support the QoE configuration. Nonetheless, the UE 120 may continue to collect QoE measurements in accordance with the QoE configuration, and upon handover to another cell that supports the QoE configuration, the UE 120 may receive an indication to resume the QoE reporting. In some aspects, during handover from a first node (e.g., a source node) to a second node (e.g., a target node), the second node may store an unsupported QoE configuration in association with a forwarding indication. After completion of the handover, the UE 120 may continue to collect QoE measurements in accordance with the QoE configuration, and the UE 120 may provide a QoE report to the second node (e.g., that does not support the QoE configuration). Based at least in part on the forwarding indication associated with the QoE configuration, the second node may forward the QoE report to the first node (e.g., that supports the QoE configuration).

In this way, the UE 120 may continue QoE measurements in accordance with a QoE configuration even after handover to a node that does not support the QoE configuration. Moreover, the UE 120 may report the QoE measurements that are collected by the UE 120 (e.g., after a resume indication is received by the UE 120, or for forwarding to a node that does support the QoE configuration). Thus, processing resources of the UE 120 that are consumed by performing QoE measurements are utilized more efficiently (e.g., because the QoE measurements are not discarded).

FIG. 5 is a diagram illustrating an example 500 associated with QoE reporting in handover, in accordance with the present disclosure. As shown in FIG. 5, example 500 includes communication between a UE 120, a first node 505 (e.g., a wireless node), a second node 510 (e.g., a wireless node), and a third node 515 (e.g., a wireless node). In some aspects, the UE 120, the first node 505, the second node 510, and the third node 515 may be included in a wireless network, such as wireless network 100. The UE 120 may communicate with the first node 505, the second node 510, and the third node 515 via respective wireless access links, each of which may include an uplink and a downlink. The first node 505, the second node 510, and the third node 515 may communicate via backhaul interfaces (e.g., X2 interfaces).

The first node 505, the second node 510, and the third node 515 may be base stations 110, or other nodes that perform one or more functions of a base station 110. Initially, the first node 505 may be a source node in a handover of the UE 120, and the second node 510 may be a target node in the handover of the UE 120. Subsequently, the second node 510 may be a source node in a subsequent handover of the UE 120, and the third node 515 may be a target node in the subsequent handover of the UE 120. The first node 505 and the third node 515 may use the same RAT, which may be different from a RAT used by the second node 510. For example, the first node 505 and the third node 515 may be associated with an NG-RAN (e.g., the first node 505 and the third node 515 may use a 5G RAT), and the second node 510 may be associated with an E-UTRAN (e.g., the second node 510 may use an LTE RAT).

As shown by reference number 520, the first node 505 may transmit, and the UE 120 may receive, a QoE configuration (QoE config 1), such as a QoE measurement configuration, a QoE reporting configuration, or the like. The UE 120 may initiate the collection of QoE measurements in accordance with the QoE configuration based at least in part on receiving the QoE configuration. The first node 505 and the third node 515 may support (e.g., fully support) the QoE configuration. The second node 510 may not support (e.g., does not fully support or only partially supports) the QoE configuration.

As shown by reference number 525, in connection with a handover of the UE 120 from the first node 505 to the second node 510, the first node 505 may determine whether the second node 510 supports the QoE configuration (QoE config 1). For example, the first node 505 may determine that the second node 510 does not support the QoE configuration based at least in part on QoE capabilities of the second node 510. For example, the first node 505 may have obtained (e.g., via a communication from an OAM system, the network controller 130, or another controlling node) information indicating QoE capabilities of the second node 510, and the first node 505 may determine that the second node 510 does not support the QoE configuration based at least in part on the information.

As shown by reference number 530, the first node 505 (e.g., the source node) may transmit, and the second node 510 (e.g., the target node) may receive, a request message (e.g., a handover request). The request message may indicate the handover of the UE 120 to the second node 510. In some aspects, the request message may include the QoE configuration (QoE config 1). In some aspects, the request message may indicate that QoE reporting for the QoE configuration is to be suspended (e.g., the request message may include a suspension flag or other indicator for the QoE configuration). For example, the first node 505 may transmit the request message indicating that QoE reporting for the QoE configuration is to be suspended based at least in part on determining that the second node 510 does not support the QoE configuration, as described above.

As shown by reference number 535, the second node 510 may determine whether the second node 510 supports the QoE configuration (QoE config 1). For example, the second node 510 may determine whether the second node 510 supports the QoE configuration when the request message does not indicate whether QoE reporting for the QoE configuration is to be suspended. In other words, the first node 505 may determine whether the second node 510 supports the QoE configuration, and the first node 505 may indicate in the request message whether QoE reporting is to be suspended (e.g., based at least in part on determining whether the second node 510 supports the QoE configuration); or if no indication is provided in the request message, the second node 510 may determine whether the second node 510 supports the QoE configuration. The second node 510 may determine that the second node 510 does not support the QoE configuration based at least in part on QoE capabilities of the second node 510, as described above.

As shown by reference number 540, the second node 510 may transmit, and the first node 505 may receive, a response message (e.g., a handover response). The response message may acknowledge (e.g., accept) the handover of the UE 120. In some aspects, the response message may indicate that QoE reporting for the QoE configuration (QoE config 1) is to be suspended. For example, based at least in part on a determination by the second node 510 that the second node 510 does not support the QoE configuration, the response message may include an indication (e.g., an explicit indication, such as a flag or another indicator) that QoE reporting for the QoE configuration is to be suspended. As another example, based at least in part on the request message indicating that the QoE configuration is to be suspended, the response message may include an acknowledgment (ACK) that QoE reporting for the QoE configuration is to be suspended. In some aspects, the response message may include a different QoE configuration (QoE config 2) that is supported (e.g., fully supported) by the second node 510. For example, the second node 510 may determine the different QoE configuration that is supported by the second node 510 (e.g., based at least in part on the QoE capabilities of the second node 510), and provide the different QoE configuration in the response message.

As shown by reference number 545, the second node 510 may store the QoE configuration (QoE config 1). Additionally, if the different QoE configuration (QoE config 2) is provided by the second node 510, the second node 510 may store the different QoE configuration. In this way, the second node 510 may forward the QoE configuration and/or the different QoE configuration to another node (e.g., the third node 515) in connection with a subsequent handover of the UE 120.

In connection with the handover of the UE 120, the second node 510 may refrain from establishing a radio bearer (e.g., SRB4) for QoE reporting for the QoE configuration (QoE config 1) (e.g., because the second node 510 does not support the QoE configuration). In connection with the handover of the UE 120, and if the different QoE configuration (QoE config 2) is provided by the second node 510, the second node 510 may establish a radio bearer (e.g., SRB4) for QoE reporting for the different QoE configuration.

As shown by reference number 550, the first node 505 may transmit, and the UE 120 may receive, a message indicating the handover to the second node 510 (e.g., that does not support the QoE configuration configured for the UE 120). For example, the message may be an RRC reconfiguration message that includes a handover command for the second node 510. In some aspects, the message may include the different QoE configuration (QoE config 2), which is supported by the second node 510 (e.g., the message may configure the UE 120 with the different QoE configuration).

In some aspects, the message may include an indication (e.g., an explicit indication) to suspend QoE reporting for the QoE configuration (QoE config 1). In some aspects, the UE 120 may determine to suspend QoE reporting for the QoE configuration (e.g., based at least in part on an implicit indication). For example, the UE 120 may determine to suspend the QoE reporting based at least in part on a determination that a radio bearer (e.g., SRB4) for the QoE reporting for the second node 510 is not established (e.g., the radio bearer is not configured for the UE 120). Additionally, or alternatively, the UE 120 may determine to suspend the QoE reporting based at least in part on RAT information associated with the first node 505 and/or the second node 510. For example, the UE 120 may determine to suspend the QoE reporting based at least in part on a determination that the handover to the second node 510 is an inter-RAT handover (e.g., the first node 505 and the second node 510 use different RATs).

As shown by reference number 555, after completion of the handover to the second node 510, the UE 120 may perform QoE measurements in accordance with the QoE configuration (QoE config 1). That is, the UE 120 may continue to perform measurements in accordance with the QoE configuration even though the QoE configuration is not supported by the second node 510. If the UE 120 is configured with the different QoE configuration (QoE config 2), the UE 120 may perform QoE measurements in accordance with the different QoE configuration. Based at least in part on receiving (e.g., in the message) the indication to suspend QoE reporting for the QoE configuration and/or determining to suspend QoE reporting for the QoE configuration, as described above, the UE 120 may suspend QoE reporting for the QoE configuration. Accordingly, the UE 120 may store the QoE measurements obtained in accordance with the QoE configuration (QoE config 1) for later reporting.

As shown by reference number 560, the UE 120 may transmit, and the second node 510 may receive, a QoE report in accordance with the different QoE configuration (QoE config 2), which is supported by the second node 510. The QoE report may be based at least in part on the QoE measurements obtained in accordance with the different measurement configuration (e.g., the QoE report may include the QoE measurements). The second node 510 may transmit (e.g., forward) the QoE report to a QoE server, as described above in connection with FIG. 3.

As shown by reference number 565, in connection with another handover of the UE 120 from the second node 510 (e.g., the source node) to the third node 515 (e.g., the target node), the second node 510 may transmit, and the third node 515 may receive, a request message (e.g., a handover request), in a similar manner as described above. The request message may indicate the handover of the UE 120 to the third node 515. In some aspects, the request message may include the QoE configuration (QoE config 1). For example, the second node 510 may retrieve the QoE configuration from storage for inclusion in the request message. In some aspects, the request message may indicate that QoE reporting for the QoE configuration is suspended (e.g., the request message may include a suspension flag or another indicator for the QoE configuration). If the different measurement configuration (QoE config 2) was stored by the second node 510, as described above, the request message may include the different QoE configuration. For example, the second node 510 may retrieve the different QoE configuration from storage for inclusion in the request message.

In some aspects, the request message may include the QoE configuration (e.g., for which QoE reporting is suspended) if a threshold quantity of handovers of the UE 120 is not exceeded and/or if the handover to the third node 515 is within a time window. For example, the second node 510 may include the QoE configuration in the request message based at least in part on a determination that a quantity of handovers of the UE 120, for which the QoE configuration was forwarded, is less than a threshold quantity of handovers for which the QoE configuration is to be forwarded. As another example, the second node 510 may include the QoE configuration in the request message based at least in part on a determination that the handover to third node 515 is within a time window (e.g., from when the QoE configuration was first forwarded in connection with a handover of the UE 120). In this way, the QoE configuration, for which QoE reporting is suspended, will not be forwarded indefinitely in connection with handovers of the UE 120.

As shown by reference number 570, the third node 515 may determine whether the third node 515 supports the QoE configuration (QoE config 1) and/or the different QoE configuration (QoE config 2). For example, the third node 515 may determine that the third node 515 supports (e.g., fully supports) the QoE configuration and/or the different QoE configuration based at least in part on QoE capabilities of the third node 515, in a similar manner as described above.

As shown by reference number 575, the third node 515 may transmit, and the second node 510 may receive, a response message (e.g., a handover response), in a similar manner as described above. The response message may acknowledge (e.g., accept) the handover of the UE 120. In some aspects, the response message may indicate that QoE reporting for the QoE configuration (QoE config 1) is to be resumed. For example, based at least in part on a determination by the third node 515 that the third node 515 supports the QoE configuration, the response message may include an indication (e.g., a resume indication, such as a resume flag or another indicator) that QoE reporting for the QoE configuration is to be resumed.

As shown by reference number 580, the second node 510 may transmit, and the UE 120 may receive, a message indicating the handover to the third node 515 (e.g., that supports the QoE configuration configured for the UE 120), in a similar manner as described above. For example, the message may be an RRC reconfiguration message that includes a handover command for the third node 515.

In some aspects, the message may include an indication (e.g., an explicit indication) to resume QoE reporting for the QoE configuration (QoE config 1). In some aspects, the UE 120 may determine to resume QoE reporting for the QoE configuration (e.g., based at least in part on an implicit indication). For example, the UE 120 may determine to resume the QoE reporting based at least in part on a determination that a radio bearer (e.g., SRB4) for the QoE reporting for the third node 515 is established (e.g., the radio bearer is configured for the UE 120). Additionally, or alternatively, the UE 120 may determine to resume the QoE reporting based at least in part on RAT information associated with the third node 515. For example, the UE 120 may determine to resume the QoE reporting based at least in part on a determination that the third node 515 uses the same RAT as the first node 605 that supported the QoE configuration.

Based at least in part on receiving (e.g., in the message) the indication to resume QoE reporting for the QoE configuration and/or determining to resume QoE reporting for the QoE configuration, the UE 120 may resume (e.g., after completion of the handover to the third node 515) QoE reporting for the QoE configuration. For example, the UE 120 may retrieve the QoE measurements (e.g., the suspended QoE measurements), obtained in accordance with the QoE configuration (QoE config 1), that were previously stored.

As shown by reference number 585, the UE 120 may transmit, and the third node 515 may receive, a QoE report in accordance with the QoE configuration (QoE config 1), which is supported by the third node 515. The QoE report may be based at least in part on the QoE measurements, obtained in accordance with the QoE configuration, that were retrieved from storage (e.g., the QoE report may include the QoE measurements). If the UE 120 is configured with the different QoE configuration (QoE config 2), the UE 120 may transmit, and the third node 515 may receive, a QoE report in accordance with the different QoE configuration, which is also supported by the third node 515. The third node 515 may transmit (e.g., forward) the QoE report(s) to a QoE server, as described above in connection with FIG. 3.

In this way, during a handover of the UE 120 to a node that does not support a QoE configuration configured for the UE 120, the UE 120 may continue to collect QoE measurements in accordance with the QoE configuration. Rather than discarding the measurements, the UE 120 may suspend reporting of the measurements, and may subsequently resume reporting of the measurements after moving to a cell that supports the QoE configuration. Accordingly, processing resources of the UE 120, which may otherwise be used for performing QoE measurements that are subsequently discarded, are used more efficiently.

As indicated above, FIG. 5 is provided as an example. Other examples may differ from what is described with respect to FIG. 5.

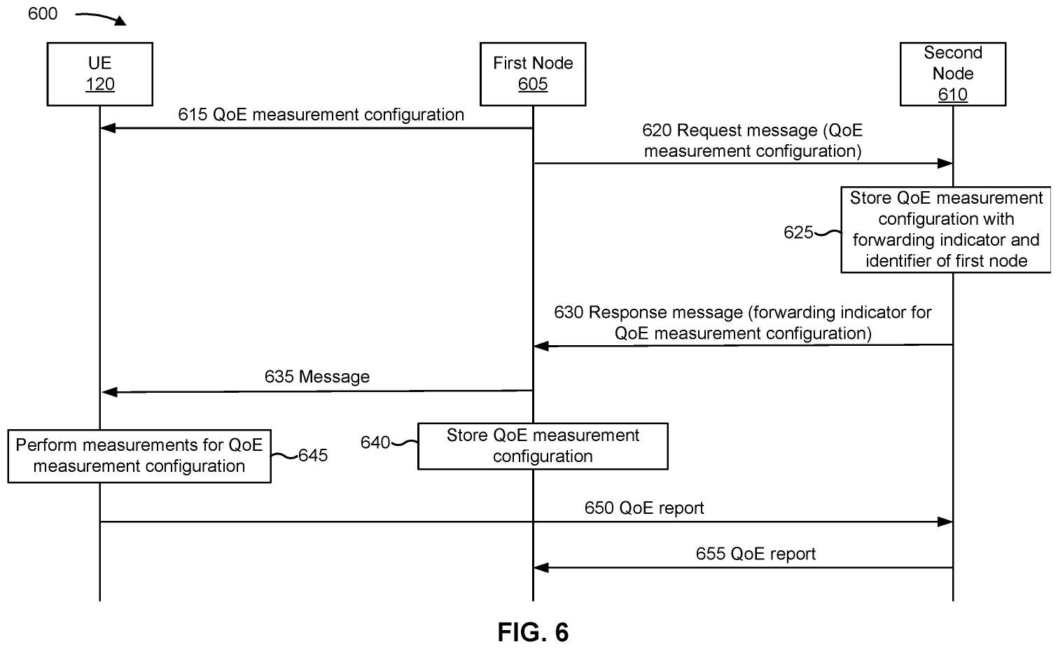

FIG. 6 is a diagram illustrating an example 600 associated with QoE reporting in handover, in accordance with the present disclosure. As shown in FIG. 6, example 600 includes communication between a UE 120, a first node 605 (e.g., a wireless node), and a second node 610 (e.g., a wireless node). In some aspects, the UE 120, the first node 605, and the second node 610 may be included in a wireless network, such as wireless network 100. The UE 120 may communicate with the first node 605 and the second node 610 via respective wireless access links, each of which may include an uplink and a downlink. The first node 605 and the second node 610 may communicate via backhaul interfaces (e.g., X2 interfaces).

The first node 605 and the second node 610 may be base stations 110, or other nodes that perform one or more functions of a base station 110. The first node 605 may be a source node in a handover of the UE 120, and the second node 610 may be a target node in the handover of the UE 120. The first node 605 may use a RAT that may be different from a RAT used by the second node 610. For example, the first node 605 may be associated with an NG-RAN (e.g., the first node 605 may use a 5G RAT), and the second node 610 may be associated with an E-UTRAN (e.g., the second node 610 may use an LTE RAT).

As shown by reference number 615, the first node 605 may transmit, and the UE 120 may receive, a QoE configuration, such as a QoE measurement configuration, a QoE reporting configuration, or the like. The UE 120 may initiate the collection of QoE measurements in accordance with the QoE configuration based at least in part on receiving the QoE configuration. The first node 605 may support (e.g., fully support) the QoE configuration. The second node 610 may not support (e.g., does not fully support or only partially supports) the QoE configuration.

As shown by reference number 620, in connection with a handover of the UE 120 from the first node 605 to the second node 610, the first node 605 (e.g., the source node) may transmit, and the second node 610 (e.g., the target node) may receive, a request message (e.g., a handover request). The request message may indicate the handover of the UE 120 to the second node 610. In some aspects, the request message may include the QoE configuration.

As shown by reference number 625, the second node 610 may store the QoE configuration received in the request message. In some aspects, the second node 610 may store the QoE configuration in association with a forwarding indication (e.g., a forwarding indicator associated with the QoE configuration may be set to a “true” value) and/or in association with an identifier of the first node 605 (e.g., a cell global identifier (CGI) associated with the first node 605). In some aspects, the second node 610 may store the QoE configuration in association with the forwarding indication based at least in part on a determination that the second node 610 does not support the QoE configuration, as described above. In some aspects, the request message may include a forwarding indication (e.g., based at least in part on a determination by the first node 605 that the second node 610 does not support the QoE configuration, as described above), and the second node 610 may store the QoE configuration in association with the forwarding indication based at least in part on the forwarding indication of the request message.

In some aspects, in connection with the handover of the UE 120, the second node 610 may establish a radio bearer (e.g., SRB4) for QoE reporting for the QoE configuration (e.g., even though the second node 610 does not support the QoE configuration). For example, the second node 610 may establish the radio bearer based at least in part on the association of the QoE configuration with the forwarding indication.

As shown by reference number 630, the second node 610 may transmit, and the first node 605 may receive, a response message (e.g., a handover response). The response message may acknowledge (e.g., accept) the handover of the UE 120. In some aspects, the response message may indicate that QoE reporting for the QoE configuration is to be forwarded. For example, based at least in part on the association of the QoE configuration with the forwarding indication, the response message may include a forwarding indication (e.g., a forwarding indicator of the response message associated with the QoE configuration may be set to a “true” value) that QoE reporting for the QoE configuration is to be forwarded.

As shown by reference number 635, the first node 605 may transmit, and the UE 120 may receive, a message indicating the handover to the second node 610 (e.g., that does not support the QoE configuration configured for the UE 120). For example, the message may be an RRC reconfiguration message that includes a handover command for the second node 610. As shown by reference number 640, after completion of the handover to the second node 610, the first node 605 may store the QoE configuration. That is, the first node 605 may store the QoE configuration after releasing UE context for the UE 120.

As shown by reference number 645, after completion of the handover to the second node 610, the UE 120 may perform QoE measurements in accordance with the QoE configuration. That is, the UE 120 may continue to perform measurements in accordance with the QoE configuration even though the QoE configuration is not supported by the second node 610. As shown by reference number 650, the UE 120 may transmit, and the second node 610 may receive, a QoE report in accordance with the QoE configuration (e.g., for forwarding to the first node 605). The QoE report may be based at least in part on the QoE measurements obtained in accordance with the measurement configuration (e.g., the QoE report may include the QoE measurements).

As shown by reference number 655, the second node 610 may transmit, and the first node 605 may receive, the QoE report. That is, the first node 605 may receive the QoE report that was received by the second node 610 from the UE 120. In other words, the second node 610 may forward the QoE report, received from the UE 120, to the first node 605 (e.g., the second node 610 may act as a relay for the QoE report). The second node 610 may transmit the QoE report to the first node 605 based at least in part on a determination that the QoE configuration, associated with the QoE report, is associated with the forwarding indication (e.g., the forwarding indicator associated with the QoE configuration is set to a “true” value). Moreover, the second node 610 may determine to transmit the QoE report to the first node 605 based at least in part on the association of the QoE configuration with the identifier (e.g., CGI) of the first node 605. The second node 610 may transmit the QoE report to the first node 605 via a backhaul interface (e.g., an X2 interface or an Xn interface).

The first node 605 may transmit (e.g., forward) the QoE report to a QoE server, as described above in connection with FIG. 3. For example, the first node 605 may be enabled to transmit the QoE report to the QoE server based at least in part on having previously stored the QoE configuration (e.g., and therefore having the information necessary to forward the QoE report to the QoE server).

In this way, during a handover of the UE 120 to a node that does not support a QoE configuration configured for the UE 120, the UE 120 may continue to collect QoE measurements in accordance with the QoE configuration. Rather than discarding the measurements, the UE 120 may continue reporting the measurements to the node that does not support the QoE configuration, and the node may forward the measurements to another node that supports the QoE configuration. Accordingly, processing resources of the UE 120, which may otherwise be used for performing QoE measurements that are subsequently discarded, are used more efficiently.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with QoE reporting in handover.

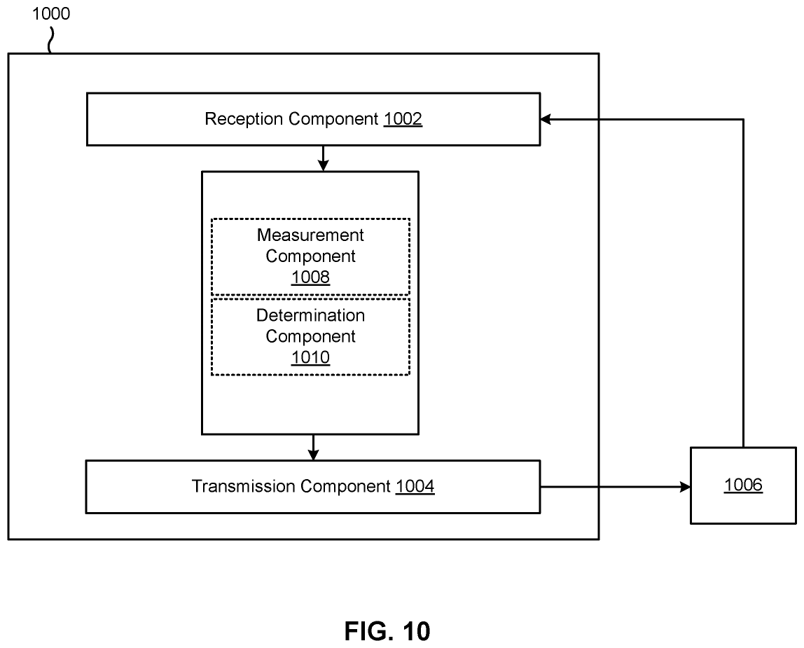

As shown in FIG. 7, in some aspects, process 700 may include receiving, from a first node, a QoE configuration (block 710). For example, the UE (e.g., using reception component 1002, depicted in FIG. 10) may receive, from a first node, a QoE configuration, as described above.

As further shown in FIG. 7, in some aspects, process 700 may include receiving, from the first node, a message indicating a handover to a second node that does not support the QoE configuration (block 720). For example, the UE (e.g., using reception component 1002, depicted in FIG. 10) may receive, from the first node, a message indicating a handover to a second node that does not support the QoE configuration, as described above.

As further shown in FIG. 7, in some aspects, process 700 may include performing, after completion of the handover to the second node, QoE measurements in accordance with the QoE configuration (block 730). For example, the UE (e.g., using measurement component 1008, depicted in FIG. 10) may perform, after completion of the handover to the second node, QoE measurements in accordance with the QoE configuration, as described above.

Process 700 may include additional aspects, such as any single aspect or any combination of aspects described below and/or in connection with one or more other processes described elsewhere herein.

In a first aspect, the message includes a different QoE configuration that is supported by the second node.

In a second aspect, alone or in combination with the first aspect, process 700 includes transmitting (e.g., using transmission component 1004, depicted in FIG. 10), to the second node, a QoE report in accordance with the different QoE configuration.

In a third aspect, alone or in combination with one or more of the first and second aspects, the message includes an indication to suspend QoE reporting for the QoE configuration.

In a fourth aspect, alone or in combination with one or more of the first through third aspects, process 700 includes determining (e.g., using determination component 1010, depicted in FIG. 10) to suspend QoE reporting for the QoE configuration based at least in part on one or more of a determination that a radio bearer for the QoE reporting for the second node is not established, or a determination that the handover is an inter-radio access technology handover.

In a fifth aspect, alone or in combination with one or more of the first through fourth aspects, process 700 includes receiving (e.g., using reception component 1002, depicted in FIG. 10), from the second node, another message indicating another handover to a third node that supports the QoE configuration, the other message including an indication to resume QoE reporting for the QoE configuration, and transmitting (e.g., using transmission component 1004, depicted in FIG. 10), to the third node, a QoE report based at least in part on the QoE measurements in accordance with the QoE configuration.

In a sixth aspect, alone or in combination with one or more of the first through fifth aspects, process 700 includes transmitting (e.g., using transmission component 1004, depicted in FIG. 10) a QoE report, based at least in part on the QoE measurements in accordance with the QoE configuration, to the second node for forwarding to the first node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a node (e.g., a first node), in accordance with the present disclosure. Example process 800 is an example where the node (e.g., node 505, node 510, node 515, node 605, and/or node 610) performs operations associated with QoE reporting in handover.

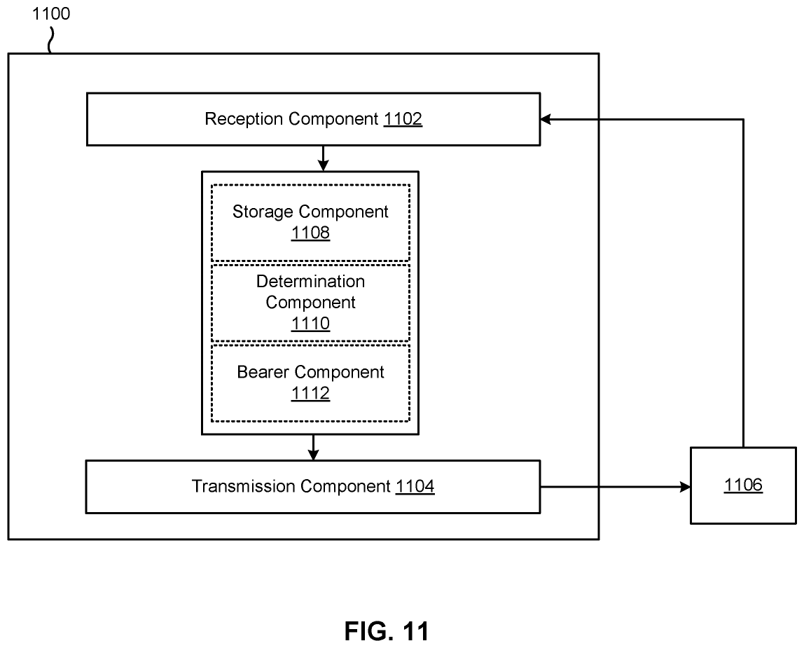

As shown in FIG. 8, in some aspects, process 800 may include transmitting, to a node (e.g., a second node), a request message indicating a handover of a UE and a QoE configuration for the UE (block 810). For example, the first node (e.g., using transmission component 1104, depicted in FIG. 11) may transmit, to the second node, a request message indicating a handover of a UE and a QoE configuration for the UE, as described above.

As further shown in FIG. 8, in some aspects, process 800 may include receiving, from the node, a response message indicating that QoE reporting for the QoE configuration is to be suspended, forwarded, or resumed (block 820). For example, the first node (e.g., using reception component 1102, depicted in FIG. 11) may receive, from the second node, a response message indicating that QoE reporting for the QoE configuration is to be suspended, forwarded, or resumed, as described above.

As further shown in FIG. 8, in some aspects, process 800 may include transmitting, to the UE, a message indicating the handover to the node (block 830). For example, the first node (e.g., using transmission component 1104, depicted in FIG. 11) may transmit, to the UE, a message indicating the handover to the second node, as described above.

Process 800 may include additional aspects, such as any single aspect or any combination of aspects described below and/or in connection with one or more other processes described elsewhere herein.

In a first aspect, the request message further indicates that the QoE reporting for the QoE configuration is to be suspended, and the response message indicates an acknowledgment that the QoE reporting for the QoE configuration is to be suspended.

In a second aspect, alone or in combination with the first aspect, the response message includes a different QoE configuration that is supported by the second node.

In a third aspect, alone or in combination with one or more of the first and second aspects, the message includes a different QoE configuration that is supported by the second node.

In a fourth aspect, alone or in combination with one or more of the first through third aspects, the message includes an indication to suspend QoE reporting for the QoE configuration.

In a fifth aspect, alone or in combination with one or more of the first through fourth aspects, the request message indicates the QoE configuration based at least in part on at least one of a determination (e.g., using determination component 1110, depicted in FIG. 11) that a threshold quantity of handovers of the UE is not exceeded, or a determination (e.g., using determination component 1110, depicted in FIG. 11) that the handover to the second node is within a time window.

In a sixth aspect, alone or in combination with one or more of the first through fifth aspects, the request message further indicates that the QoE reporting for the QoE configuration is suspended, and the response message indicates that the QoE reporting for the QoE configuration is to be resumed.

In a seventh aspect, alone or in combination with one or more of the first through sixth aspects, the message includes an indication to resume QoE reporting for the QoE configuration.

In an eighth aspect, alone or in combination with one or more of the first through seventh aspects, process 800 includes storing (e.g., using storage component 1108, depicted in FIG. 11) the QoE configuration after completion of the handover to the second node.

In a ninth aspect, alone or in combination with one or more of the first through eighth aspects, process 800 includes receiving (e.g., using reception component 1102, depicted in FIG. 11), from the second node, a QoE report in accordance with the QoE configuration that was received by the second node from the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a node (e.g., a first node), in accordance with the present disclosure. Example process 900 is an example where the node (e.g., node 505, node 510, node 515, node 605, and/or node 610) performs operations associated with QoE reporting in handover.

As shown in FIG. 9, in some aspects, process 900 may include receiving, from a node, a request message indicating a handover of a UE and a QoE configuration for the UE (block 910). For example, the first node (e.g., using reception component 1102, depicted in FIG. 11) may receive, from a second node, a request message indicating a handover of a UE and a QoE configuration for the UE, as described above.

As further shown in FIG. 9, in some aspects, process 900 may include transmitting, to the second node, a response message indicating that QoE reporting for the QoE configuration is to be suspended, forwarded, or resumed (block 920). For example, the first node (e.g., using transmission component 1104, depicted in FIG. 11) may transmit, to the second node, a response message indicating that QoE reporting for the QoE configuration is to be suspended, forwarded, or resumed, as described above.

Process 900 may include additional aspects, such as any single aspect or any combination of aspects described below and/or in connection with one or more other processes described elsewhere herein.

In a first aspect, the response message indicates that the QoE reporting for the QoE configuration is to be suspended based at least in part on a determination (e.g., using determination component 1110, depicted in FIG. 11) that the first node does not support the QoE configuration.

In a second aspect, alone or in combination with the first aspect, the request message further indicates that the QoE reporting for the QoE configuration is to be suspended, and the response message indicates an acknowledgment that the QoE reporting for the QoE configuration is to be suspended.

In a third aspect, alone or in combination with one or more of the first and second aspects, process 900 includes storing (e.g., using storage component 1108, depicted in FIG. 11) the QoE configuration.

In a fourth aspect, alone or in combination with one or more of the first through third aspects, the QoE configuration is stored in association with a forwarding indication and an identifier of the second node.

In a fifth aspect, alone or in combination with one or more of the first through fourth aspects, the response message includes a different QoE configuration that is supported by the first node.

In a sixth aspect, alone or in combination with one or more of the first through fifth aspects, process 900 includes receiving (e.g., using reception component 1102, depicted in FIG. 11), from the UE, a QoE report in accordance with the different QoE configuration.

In a seventh aspect, alone or in combination with one or more of the first through sixth aspects, the request message further indicates that the QoE reporting for the QoE configuration is suspended, and the response message indicates that the QoE reporting for the QoE configuration is to be resumed.

In an eighth aspect, alone or in combination with one or more of the first through seventh aspects, the response message indicates that the QoE reporting for the QoE configuration is to be resumed based at least in part on a determination that the first node supports the QoE configuration.

In a ninth aspect, alone or in combination with one or more of the first through eighth aspects, process 900 includes establishing (e.g., using bearer component 1112, depicted in FIG. 11) a radio bearer for the QoE reporting.

In a tenth aspect, alone or in combination with one or more of the first through ninth aspects, process 900 includes receiving (e.g., using reception component 1102, depicted in FIG. 11), from the UE, a QoE report in accordance with the QoE configuration, and transmitting, to the second node, the QoE report.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include one or more of a measurement component 1008 or a determination component 1010, among other examples.

In some aspects, the apparatus 1000 may be configured to perform one or more operations described herein in connection with FIGS. 5-6. Additionally, or alternatively, the apparatus 1000 may be configured to perform one or more processes described herein, such as process 700 of FIG. 7, or a combination thereof. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The reception component 1002 may receive, from a first node, a QoE configuration. The reception component 1002 may receive, from the first node, a message indicating a handover to a second node that does not support the QoE configuration. The measurement component 1008 may perform, after completion of the handover to the second node, QoE measurements in accordance with the QoE configuration. In some aspects, the measurement component 1008 may include a controller/processor, a memory, or a combination thereof, of the UE described above in connection with FIG. 2.

The transmission component 1004 may transmit, to the second node, a QoE report in accordance with the different QoE configuration. The determination component 1010 may determine to suspend QoE reporting for the QoE configuration based at least in part on one or more of a determination that a radio bearer for the QoE reporting for the second node is not established, or a determination that the handover is an inter-RAT handover. In some aspects, the determination component 1010 may include a controller/processor, a memory, or a combination thereof, of the UE described above in connection with FIG. 2.

The reception component 1002 may receive, from the second node, another message indicating another handover to a third node that supports the QoE configuration, the other message including an indication to resume QoE reporting for the QoE configuration. The transmission component 1004 may transmit, to the third node, a QoE report based at least in part on the QoE measurements in accordance with the QoE configuration. The transmission component 1004 may transmit a QoE report, based at least in part on the QoE measurements in accordance with the QoE configuration, to the second node for forwarding to the first node.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a node (e.g., a base station), or a node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include one or more of a storage component 1108, a determination component 1110, or a bearer component 1112, among other examples.

In some aspects, the apparatus 1100 may be configured to perform one or more operations described herein in connection with FIGS. 5-6. Additionally, or alternatively, the apparatus 1100 may be configured to perform one or more processes described herein, such as process 800 of FIG. 8, process 900 of FIG. 9, or a combination thereof. In some aspects, the apparatus 1100 and/or one or more components shown in FIG. 11 may include one or more components of the node described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described above in connection with FIG. 2. In some aspects, the transmission component 1104 may be co-located with the reception component 1102 in a transceiver.

The transmission component 1104 may transmit, to a node, a request message indicating a handover of a UE and a QoE configuration for the UE. The reception component 1102 may receive, from the node, a response message indicating that QoE reporting for the QoE configuration is to be suspended, forwarded, or resumed. The transmission component 1104 may transmit, to the UE, a message indicating the handover to the node.

The storage component 1108 may store the QoE configuration after completion of the handover to the node. In some aspects, the storage component 1108 may include a controller/processor, a memory, or a combination thereof, of the base station described above in connection with FIG. 2.

The reception component 1102 may receive, from the node, a QoE report in accordance with the QoE configuration that was received by the node from the UE. The determination component 1110 may determine that a threshold quantity of handovers of the UE is not exceeded. The determination component 1110 may determine that the handover to the node is within a time window. In some aspects, the determination component 1110 may include a controller/processor, a memory, or a combination thereof, of the base station described above in connection with FIG. 2.

The reception component 1102 may receive, from a node, a request message indicating a handover of a UE and a QoE configuration for the UE. The transmission component 1104 may transmit, to the node, a response message indicating that QoE reporting for the QoE configuration is to be suspended, forwarded, or resumed.

The storage component 1108 may store the QoE configuration. The reception component 1102 may receive, from the UE, a QoE report in accordance with a different QoE configuration. The bearer component 1112 may establish a radio bearer for the QoE reporting. In some aspects, the bearer component 1112 may include a controller/processor, a memory, or a combination thereof, of the base station described above in connection with FIG. 2.

The reception component 1102 may receive, from the UE, a QoE report in accordance with the QoE configuration. The transmission component 1104 may transmit, to the node, the QoE report. The determination component 1110 may determine that the apparatus 1100 does not support the QoE configuration. The determination component 1110 may determine that the apparatus 1100 does support the QoE configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving, from a first node, a quality of experience (QoE) configuration: receiving, from the first node, a message indicating a handover to a second node that does not support the QoE configuration; and performing, after completion of the handover to the second node, QoE measurements in accordance with the QoE configuration.
Aspect 2: The method of Aspect 1, wherein the message includes a different QoE configuration that is supported by the second node.
Aspect 3: The method of Aspect 2, further comprising: transmitting, to the second node, a QoE report in accordance with the different QoE configuration.
Aspect 4: The method of any of Aspects 1-3, wherein the message includes an indication to suspend QoE reporting for the QoE configuration.
Aspect 5: The method of any of Aspects 1-4, further comprising: determining to suspend QoE reporting for the QoE configuration based at least in part on one or more of: a determination that a radio bearer for the QoE reporting for the second node is not established; or a determination that the handover is an inter-radio access technology handover.
Aspect 6: The method of any of Aspects 1-5, further comprising: receiving, from the second node, another message indicating another handover to a third node that supports the QoE configuration, the other message including an indication to resume QoE reporting for the QoE configuration; and transmitting, to the third node, a QoE report based at least in part on the QoE measurements in accordance with the QoE configuration.
Aspect 7: The method of any of Aspects 1-3, further comprising: transmitting a QoE report, based at least in part on the QoE measurements in accordance with the QoE configuration, to the second node for forwarding to the first node.
Aspect 8: A method of wireless communication performed by a first node, comprising: transmitting, to a second node, a request message indicating a handover of a user equipment (UE) and a quality of experience (QoE) configuration for the UE; receiving, from the second node, a response message indicating that QoE reporting for the QoE configuration is to be suspended, forwarded, or resumed; and transmitting, to the UE, a message indicating the handover to the second node.
Aspect 9: The method of Aspect 8, wherein the request message further indicates that the QoE reporting for the QoE configuration is to be suspended, and wherein the response message indicates an acknowledgment that the QoE reporting for the QoE configuration is to be suspended.
Aspect 10: The method of any of Aspects 8-9, wherein the response message includes a different QoE configuration that is supported by the second node.
Aspect 11: The method of any of Aspects 8-10, wherein the message includes a different QoE configuration that is supported by the second node.
Aspect 12: The method of any of Aspects 8-11, wherein the message includes an indication to suspend QoE reporting for the QoE configuration.
Aspect 13: The method of Aspect 8, wherein the request message indicates the QoE configuration based at least in part on at least one of: a determination that a threshold quantity of handovers of the UE is not exceeded; or a determination that the handover to the second node is within a time window.
Aspect 14: The method of any of Aspects 8 or 13, wherein the request message further indicates that the QoE reporting for the QoE configuration is suspended, and wherein the response message indicates that the QoE reporting for the QoE configuration is to be resumed.
Aspect 15: The method of any of Aspects 8 or 13-14, wherein the message includes an indication to resume QoE reporting for the QoE configuration.
Aspect 16: The method of Aspect 8, further comprising: storing the QoE configuration after completion of the handover to the second node.
Aspect 17: The method of any of Aspects 8 or 16, further comprising: receiving, from the second node, a QoE report in accordance with the QoE configuration that was received by the second node from the UE.
Aspect 18: A method of wireless communication performed by a first node, comprising: receiving, from a second node, a request message indicating a handover of a user equipment (UE) and a quality of experience (QoE) configuration for the UE; and transmitting, to the second node, a response message indicating that QoE reporting for the QoE configuration is to be suspended, forwarded, or resumed.
Aspect 19: The method of Aspect 18, wherein the response message indicates that the QoE reporting for the QoE configuration is to be suspended based at least in part on a determination that the first node does not support the QoE configuration.
Aspect 20: The method of Aspect 18, wherein the request message further indicates that the QoE reporting for the QoE configuration is to be suspended, and wherein the response message indicates an acknowledgment that the QoE reporting for the QoE configuration is to be suspended.
Aspect 21: The method of any of Aspects 18-20, further comprising: storing the QoE configuration.
Aspect 22: The method of Aspect 21, wherein the QoE configuration is stored in association with a forwarding indication and an identifier of the second node.
Aspect 23: The method of any of Aspects 18-22, wherein the response message includes a different QoE configuration that is supported by the first node.
Aspect 24: The method of Aspect 23, further comprising: receiving, from the UE, a QoE report in accordance with the different QoE configuration.
Aspect 25: The method of Aspect 18, wherein the request message further indicates that the QoE reporting for the QoE configuration is suspended, and wherein the response message indicates that the QoE reporting for the QoE configuration is to be resumed.
Aspect 26: The method of Aspect 25, wherein the response message indicates that the QoE reporting for the QoE configuration is to be resumed based at least in part on a determination that the first node supports the QoE configuration.
Aspect 27: The method of Aspect 18, further comprising: establishing a radio bearer for the QoE reporting.
Aspect 28: The method of any of Aspects 18 or 27, further comprising: receiving, from the UE, a QoE report in accordance with the QoE configuration; and transmitting, to the second node, the QoE report.
Aspect 29: An apparatus for wireless communication at a device, comprising a processor; memory coupled with the processor; and instructions stored in the memory and executable by the processor to cause the apparatus to perform the method of one or more of Aspects 1-7.
Aspect 30: A device for wireless communication, comprising a memory and one or more processors coupled to the memory, the memory and the one or more processors configured to perform the method of one or more of Aspects 1-7.
Aspect 31: An apparatus for wireless communication, comprising at least one means for performing the method of one or more of Aspects 1-7.
Aspect 32: A non-transitory computer-readable medium storing code for wireless communication, the code comprising instructions executable by a processor to perform the method of one or more of Aspects 1-7.
Aspect 33: A non-transitory computer-readable medium storing a set of instructions for wireless communication, the set of instructions comprising one or more instructions that, when executed by one or more processors of a device, cause the device to perform the method of one or more of Aspects 1-7.
Aspect 34: An apparatus for wireless communication at a device, comprising a processor; memory coupled with the processor; and instructions stored in the memory and executable by the processor to cause the apparatus to perform the method of one or more of Aspects 8-17.
Aspect 35: A device for wireless communication, comprising a memory and one or more processors coupled to the memory, the memory and the one or more processors configured to perform the method of one or more of Aspects 8-17.
Aspect 36: An apparatus for wireless communication, comprising at least one means for performing the method of one or more of Aspects 8-17.
Aspect 37: A non-transitory computer-readable medium storing code for wireless communication, the code comprising instructions executable by a processor to perform the method of one or more of Aspects 8-17.
Aspect 38: A non-transitory computer-readable medium storing a set of instructions for wireless communication, the set of instructions comprising one or more instructions that, when executed by one or more processors of a device, cause the device to perform the method of one or more of Aspects 8-17.
Aspect 39: An apparatus for wireless communication at a device, comprising a processor; memory coupled with the processor; and instructions stored in the memory and executable by the processor to cause the apparatus to perform the method of one or more of Aspects 18-28.
Aspect 40: A device for wireless communication, comprising a memory and one or more processors coupled to the memory, the memory and the one or more processors configured to perform the method of one or more of Aspects 18-28.
Aspect 41: An apparatus for wireless communication, comprising at least one means for performing the method of one or more of Aspects 18-28.
Aspect 42: A non-transitory computer-readable medium storing code for wireless communication, the code comprising instructions executable by a processor to perform the method of one or more of Aspects 18-28.
Aspect 43: A non-transitory computer-readable medium storing a set of instructions for wireless communication, the set of instructions comprising one or more instructions that, when executed by one or more processors of a device, cause the device to perform the method of one or more of Aspects 18-28.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a first node, a quality of experience (QoE) configuration;
receiving, from the first node, a message indicating a handover to a second node that does not support the QoE configuration; and
performing, after completion of the handover to the second node, QoE measurements in accordance with the QoE configuration.

2. The method of claim 1, wherein the message includes a different QoE configuration that is supported by the second node.

3. The method of claim 2, further comprising:
transmitting, to the second node, a QoE report in accordance with the different QoE configuration.

4. The method of claim 1, wherein the message includes an indication to suspend QoE reporting for the QoE configuration.

5. The method of claim 1, further comprising:
determining to suspend QoE reporting for the QoE configuration based at least in part on one or more of:
a determination that a radio bearer for the QoE reporting for the second node is not established; or
a determination that the handover is an inter-radio access technology handover.

6. The method of claim 1, further comprising:
receiving, from the second node, another message indicating another handover to a third node that supports the QoE configuration, the other message including an indication to resume QoE reporting for the QoE configuration; and
transmitting, to the third node, a QoE report based at least in part on the QoE measurements in accordance with the QoE configuration.

7. The method of claim 1, further comprising:
transmitting a QoE report, based at least in part on the QoE measurements in accordance with the QoE configuration, to the second node for forwarding to the first node.

8. A method of wireless communication performed by a first node, comprising:
transmitting, to a second node, a request message indicating a handover of a user equipment (UE) and a quality of experience (QoE) configuration for the UE;
receiving, from the second node, a response message indicating that QoE reporting for the QoE configuration is to be suspended, forwarded, or resumed; and
transmitting, to the UE, a message indicating the handover to the second node.

9. The method of claim 8, wherein the request message further indicates that the QoE reporting for the QoE configuration is to be suspended, and wherein the response message indicates an acknowledgment that the QoE reporting for the QoE configuration is to be suspended.

10. The method of claim 8, wherein the response message includes a different QoE configuration that is supported by the second node.

11. The method of claim 8, wherein the message includes a different QoE configuration that is supported by the second node.

12. The method of claim 8, wherein the message includes an indication to suspend QoE reporting for the QoE configuration.

13. The method of claim 8, wherein the request message indicates the QoE configuration based at least in part on at least one of:
a determination that a threshold quantity of handovers of the UE is not exceeded; or
a determination that the handover to the second node is within a time window.

14. The method of claim 8, wherein the request message further indicates that the QoE reporting for the QoE configuration is suspended, and
wherein the response message indicates that the QoE reporting for the QoE configuration is to be resumed.

15. The method of claim 8, wherein the message includes an indication to resume QoE reporting for the QoE configuration.

16. The method of claim 8, further comprising:
storing the QoE configuration after completion of the handover to the second node.

17. The method of claim 8, further comprising:
receiving, from the second node, a QoE report in accordance with the QoE configuration that was received by the second node from the UE.

18. A method of wireless communication performed by a first node, comprising:
receiving, from a second node, a request message indicating a handover of a user equipment (UE) and a quality of experience (QoE) configuration for the UE; and
transmitting, to the second node, a response message indicating that QoE reporting for the QoE configuration is to be suspended, forwarded, or resumed.

19. The method of claim 18, wherein the response message indicates that the QoE reporting for the QoE configuration is to be suspended based at least in part on a determination that the first node does not support the QoE configuration.

20. The method of claim 18, wherein the request message further indicates that the QoE reporting for the QoE configuration is to be suspended, and
wherein the response message indicates an acknowledgment that the QoE reporting for the QoE configuration is to be suspended.

21. The method of claim 18, further comprising:
storing the QoE configuration.

22. The method of claim 21, wherein the QoE configuration is stored in association with a forwarding indication and an identifier of the second node.

23. The method of claim 18, wherein the response message includes a different QoE configuration that is supported by the first node.

24. The method of claim 23, further comprising:
receiving, from the UE, a QoE report in accordance with the different QoE configuration.

25. The method of claim 18, wherein the request message further indicates that the QoE reporting for the QoE configuration is suspended, and
wherein the response message indicates that the QoE reporting for the QoE configuration is to be resumed.

26. The method of claim 25, wherein the response message indicates that the QoE reporting for the QoE configuration is to be resumed based at least in part on a determination that the first node supports the QoE configuration.

27. The method of claim 18, further comprising:
establishing a radio bearer for the QoE reporting.

28. The method of claim 18, further comprising:
receiving, from the UE, a QoE report in accordance with the QoE configuration; and
transmitting, to the second node, the QoE report.

29. A user equipment (UE) for wireless communication, comprising:
a memory; and
one or more processors, coupled to the memory, configured to:
receive, from a first node, a quality of experience (QoE) configuration;
receive, from the first node, a message indicating a handover to a second node that does not support the QoE configuration; and
perform, after completion of the handover to the second node, QoE measurements in accordance with the QoE configuration.

30. The UE of claim 29, wherein the one or more processors are further configured to:
receive, from the second node, another message indicating another handover to a third node that supports the QoE configuration, the other message including an indication to resume QoE reporting for the QoE configuration; and
transmit, to the third node, a QoE report based at least in part on the QoE measurements in accordance with the QoE configuration.
